(19) United States
(12) Patent Application Publication
(10) Pub. No.: US 2019/0263448 A1
(43) Pub. Date: Aug. 29, 2019

(54) SEMI-TRAILER HAVING STEERING AXLES

(71) Applicant: Kart Performance Trailers, Kuusalu alevik (EE)

(72) Inventors: Rauno Lukka, Kuusalu alevik (EE); Rasmus Tuvikene, Kuusalu alevik (EE); Janno Tooming, Kuusalu alevik (EE)

(21) Appl. No.: 16/286,951

(22) Filed: Feb. 27, 2019

Related U.S. Application Data
(60) Provisional application No. 62/635,748, filed on Feb. 27, 2018.

(51) Int. Cl. B62D 13/04; B62D 5/12

(52) U.S. Cl. CPC B62D 13/04; B62D 5/12

(57) ABSTRACT

A steerable semi-trailer including first and second steering axles arranged in a tandem configuration; a first turning block coupled with the first steering axle and first and second steering cylinders; a second turning block coupled with the second steering axle; a synchronizing member coupling rotational movement of the first and second turning blocks; and a kingpin assembly having a steering arm connected to a pivoting lever, and first and second command cylinders connected to opposing ends of the lever and hydraulically coupled to the first and second steering cylinders in which movement of the steering arm causes pivoting movement of the lever, thereby actuating the first and second command cylinders thereby causing actuation of the first and second steering cylinders and consequential steering of the first and second steering axles.

### CROSS REFERENCE TO RELATED APPLICATION(S)

This U.S. Non-Provisional patent application claims priority from U.S. Provisional Patent Application No. 62/635,748 filed Feb. 27, 2018 entitled “Semi-Trailer Having Steering Axles”, which is incorporated by reference in its entirety herein.

### TECHNICAL FIELD

The present invention relates generally to the field of semi-trailers, and more particularly, to a semi-trailer having steering tandem axles to enhance the turning radius and overall maneuverability of the semi-trailer.

### BACKGROUND

Semi-trucks and semi-trailers are in widespread use throughout the world to transport goods, vehicles, and other cargo. Due to industry demands, trailer length and payload capacities have increased to meet such demands. While increased trailer length and payload capacity allows a greater amount of cargo and heavier payloads to be transported, longer length and heavier semi-trailers are more difficult to maneuver, particularly in congested urban areas.

To handle the weight distribution associated with long length trailers and/or heavy payloads, semi-trailers can be equipped with additional axles and/or spaced axles. While spaced axles, configured as individual axles or tandem groups of axles, enhance ride quality, they disadvantageously decrease the turning radius of the semi-trailer. Poor maneuverability and decreased turning radius can lead to wear-and-tear on the trailer components, increasing costs and requiring more frequent service and replacement of worn and damaged components. In addition, trailer maneuverability difficulties can create road hazards, increase the likelihood of property damage, and add to congestion in urban areas.

While semi-trailers having a steerable axle are known from the prior art, such trailers typically have a fixed front axle and a single steerable rear axle, and therefore do not address tandem axle configurations including two or more adjacent tandem axles. Therefore, what is needed is a steerable axle solution for tandem axle trailers wherein at least two adjacent axles steer together to enhance maneuverability, and particularly turn radius.

### SUMMARY

The steerable-trailers and tandem axle configurations disclosed herein enhance overall maneuverability and turn radius of semi-trailers thus overcoming the problems currently observed with conventional semi-trailers. Specifically disclosed is a steerable semi-trailer including first and second steering axles arranged in a tandem configuration; a first turning block coupled with the first steering axle and first and second steering cylinders; a second turning block coupled with the second steering axle; a synchronizing member coupling rotational movement of the first and second turning blocks; and a kingpin assembly having a steering arm connected to a pivoting lever, and first and second command cylinders connected to opposing ends of the lever and hydraulically coupled to the first and second steering cylinders in which movement of the steering arm causes pivoting movement of the lever, thereby actuating the first and second command cylinders thereby causing actuation of the first and second steering cylinders and consequential steering of the first and second steering axles.

In certain aspects, the steerable semi-trailer further includes a non-steering axle spaced apart from both the first and second steering axles.

In certain aspects, the first and second steering axles are proximate a back end of the semi-trailer and the non-steering axle is proximate a front end of the semi-trailer. In alternative aspects, the first and second steering axles are proximate a front end of the semi-trailer and the non-steering axle is proximate a back end of the semi-trailer.

In certain aspects, the semi-trailers include wheels (e.g., wheel pairs) arranged on each of the first and second steering axles and non-steering axle.

In certain aspects, the first turning block is rotatable and rotation of the first turning block steers wheels of the front axle.

In certain aspects, the rotation of the first turning block is caused by actuation of the first and second steering cylinders, which are actuated by command cylinders associated with the kingpin assembly.

In certain aspects, the second turning block is associated with the rear axle and is interconnected with first and second steering arms associated with wheels of the rear axle.

In certain aspects, the first and second steering axles steer together in the same direction.

In certain aspects, the first and second steering axles steer together to the same degree.

In certain aspects, the first and second turning blocks are coupled together by the synchronizing member such that the first and second steering axles steer simultaneously in the same direction and degree.

In certain aspects, the lever of the kingpin assembly pivots about a vertical pivot axis and piston ends of the first and second command cylinders pivotally attach proximate opposite ends of the lever, and on opposite sides of the pivot axis, such that rotation of the lever in a first direction lengthens one command cylinder while shortening the other, and rotation of the lever in a second direction opposite the first direction has the opposite effect on the cylinder lengths with actuation of the command cylinders causing actuation of the steering cylinders thereby causing the wheels to steer in the commanded direction.

In certain aspects, the first direction of rotation of the lever is in a clockwise direction.

In certain aspects, the second direction of rotation of the lever is in a counterclockwise direction.

Embodiments of the invention can include one or more or any combination of the above features and configurations.

Additional features, aspects and advantages of the invention will be set forth in the detailed description which follows, and in part will be readily apparent to those skilled in the art from that description or recognized by practicing the invention as described herein. It is to be understood that both the foregoing general description and the following detailed description present various embodiments of the invention, and are intended to provide an overview or framework for understanding the nature and character of the invention as it is claimed. The accompanying drawings are included to provide a further understanding of the invention, and are incorporated in and constitute a part of this specification.

### BRIEF DESCRIPTION OF THE DRAWINGS

These and other features, aspects and advantages of the present invention are better understood when the following detailed description of the invention is read with reference to the accompanying drawings, in which:

FIG. 1 is an overhead view of steerable tandem axles of a semi-trailer, according to an embodiment of the invention;

FIG. 2 is a perspective view of portions of the steerable axles shown in FIG. 1;

FIG. 3 is an exploded view of steering components associated with the steerable axles shown in FIG. 1;

FIG. 4 is an overhead view of three adjacent axles of a semi-trailer, wherein two adjacent axles in tandem are steerable and the third axle is fixed;

FIG. 5 is a perspective view of the axle configuration shown in FIG. 4;

FIG. 6 is a side elevation view of the axle configuration show in FIG. 4;

FIG. 7 is a bottom perspective view of the axle configuration shown in FIG. 4;

FIG. 8 is an isometric view of an assembled kingpin assembly according to the present invention; and

FIG. 9 is an exploded view of the kingpin assembly shown in FIG. 8.

### DETAILED DESCRIPTION

The present invention will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention. Like reference numbers refer to like elements throughout the various drawings.

The inventive concepts disclosed herein are generally directed to a semi-trailer configured with at least one pair of adjacent steering axles. In a particular embodiment, the semi-trailer is configured with a plurality of adjacent axles wherein at least two of the adjacent axles are steerable. In another particular embodiment, the semi-trailer is configured with three adjacent axles including a front axle, a middle axle, and a rear axle, wherein the front and middle axles are steering axles and the rear axle is fixed. In the various axle configurations disclosed herein, regardless of axle location and number of adjacent axles, at least two axles are adjacent and are steerable in order to enhance maneuverability of the semi-trailer, among other advantages. In a particular embodiment, the semi-trailer is a vehicle carrier or auto transporter adapted to be pulled by a semi-truck or tractor by way of, for example, a fifth wheel coupling.

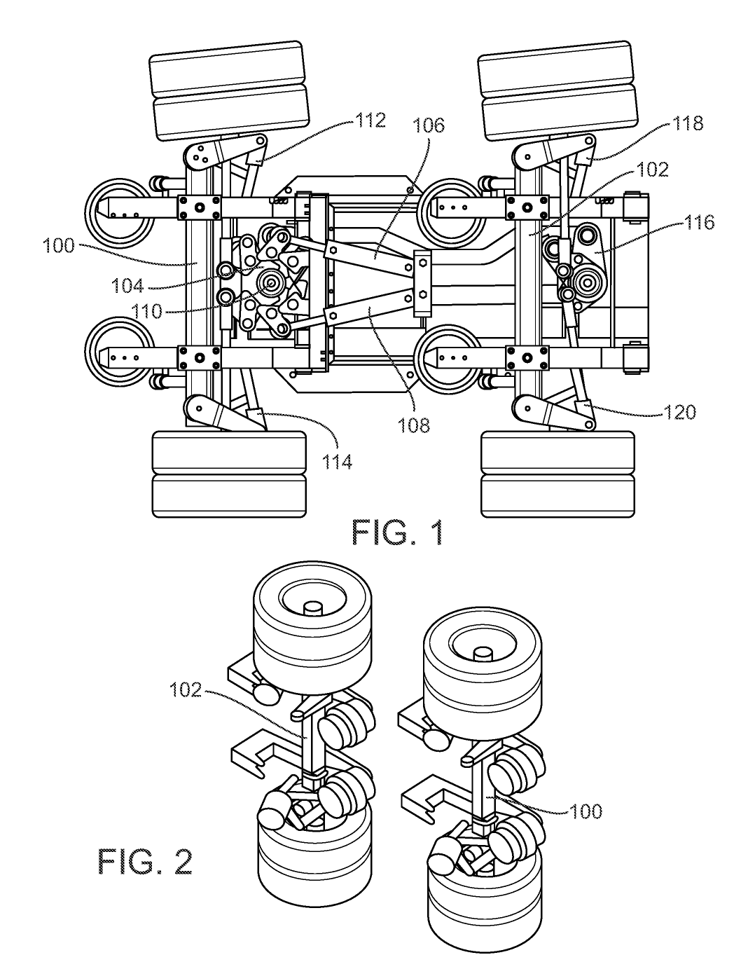

Referring to FIGS. 1 and 2, a pair of adjacent or tandem axles is shown generally including a front axle 100 and a rear axle 102. The terms “front” and “rear” with respect to the axles is intended to denote the position of each axle relative to the position of the other axle of the tandem pair, and is not intended to denote or limit the position of either axle with respect to the semi-trailer. For example, the semi-trailer according to the present invention may be configured with a single tandem axle pair positioned proximate a back of the trailer. Alternatively, the single tandem axle pair can be positioned proximate the front of the semi-trailer, or the semi-trailer can be configured with more than one tandem axle pair wherein the tandem axle pairs are positioned close together or space apart. The position and number of axle pairs equipped on a particular semi-trailer may vary based on the trailer length and anticipated carrying payload, among other factors. The term “semi-trailer” as used herein denotes any type of trailer configured to be pulled by a semi-truck including, but not limited to, semi-trailers and full trailers, and is not limited to only trailers lacking a front axle.

FIGS. 1 and 2 show one configuration of two adjacent steering axles. Each of the front and rear axles 100, 102 are steerable, wherein the term “steerable” means that the wheels of such axles or wheel pairs are able to turn in different directions. Each of the front and rear axles 100, 102 are configured with dual wheels. The ability to steer the axle wheels ensures that the wheels roll and not slip when steering the semi-trailer.

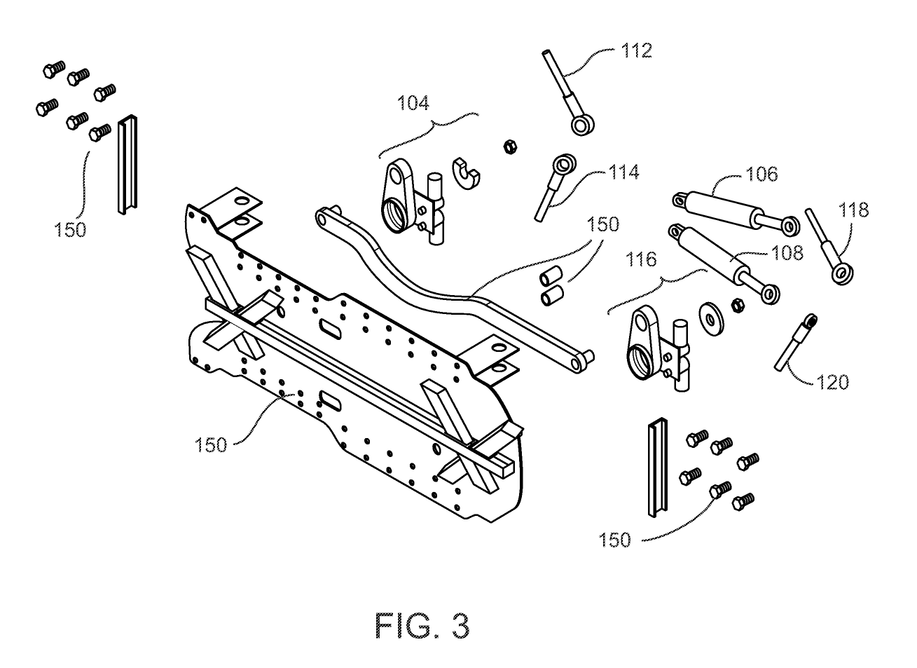

A first turning block 104 coupled with the front axle 100 is pivotally connected to first and second steering cylinders 106, 108, which may be hydraulic cylinders. The piston rods of the first and second steering cylinders 106, 108 are pivotally connected to opposite ends of the first turning block 104 such that the piston rods cooperatively extend/retract or retract/extend to cause rotational movement of the first turning block 104 about a vertical pivot axis 110. The first turning block 104 is further coupled to first and second steering arms 112, 114 associated with the left and right wheels pairs, for example, through a steering arm arrangement as shown in FIG. 3, which are further attached to portions 150 of trailer frame as shown in FIGS. 3-5.

Rotation of the first turning block 104 causes steering of the wheels of the front axle 100. Rotation of the first turning block 104 is caused by actuation of the first and second steering cylinders 106, 108, which are actuated by command cylinders associated with a kingpin assembly (described in detail below) through hydraulic conduits. A second turning block 116 associated with the rear axle 102 is interconnected with first and second steering arms 118, 120 associated with the right and left wheels pairs of the rear axle 102, for example, through a steering arm arrangement similar to the front axle arrangement and as shown in FIG. 3, which are further attached to portions 150 of trailer frame as shown in FIGS. 3-5.

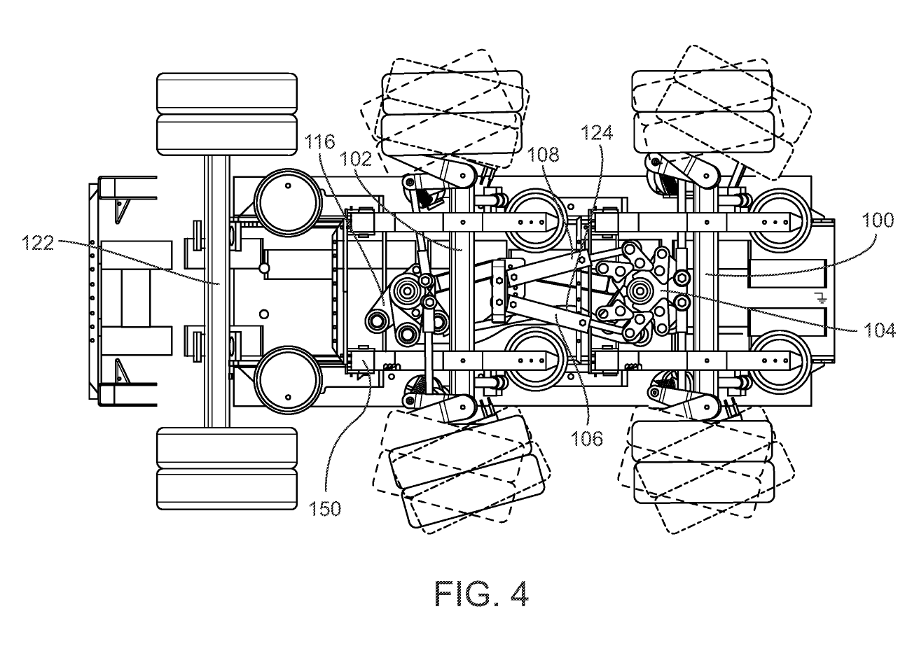

Referring to FIG. 4, in a particular configuration, the front and rear axles 100, 102 are steering axles and the rear axle 102 is positioned adjacent a fixed or non-steering axle 122 included for adding stability to the semi-trailer, among other purposes. Thus, the configuration shown in FIG. 4 is a three adjacent axle arrangement wherein two adjacent axles are steering axles and the third axle is not a steering axle. Various achievable wheel angles are shown in overlap illustrating that the wheels of the first and second steering axles 100, 102 are able to steer left or right. The first and second turning blocks 104, 116 are coupled through a synchronizing member 124 such that rotation of the first turning block 104 causes rotation of the second turning block 116, such that the wheels of the two steering axles steer together in the same direction and to the same degree. In an alternative embodiment, the synchronizing member 124 can be tuned or customized such that the adjacent axle wheels steer in the same direction, but to different degrees or amounts. Thus, the steering ratio between axles can be equal or different. In this arrangement, the command cylinders cause actuation of the first and second steering cylinders 106, 108, thereby causing rotational movement in both the first and second turning blocks 104, 116 and consequently steering motion in the axles.

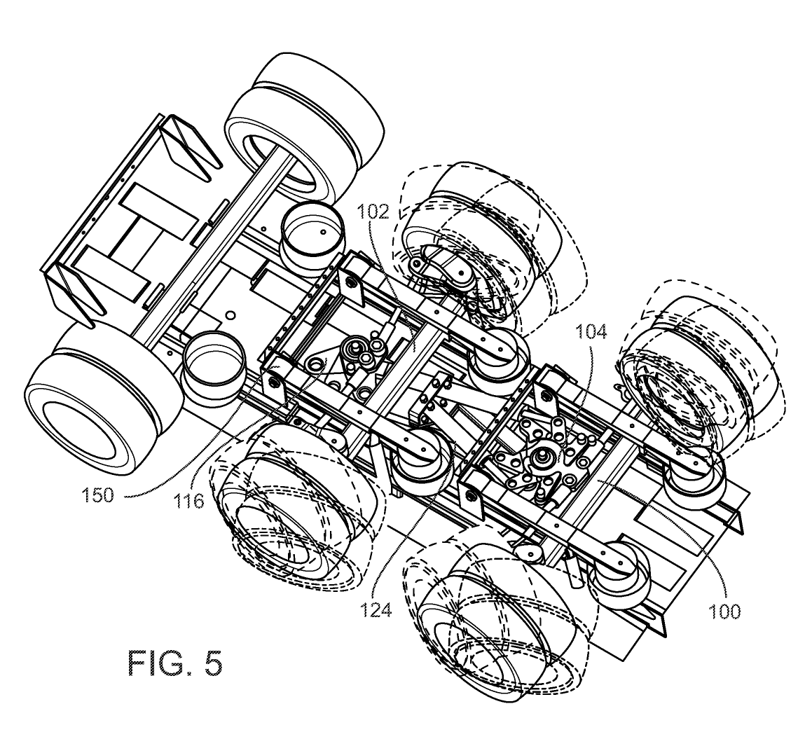

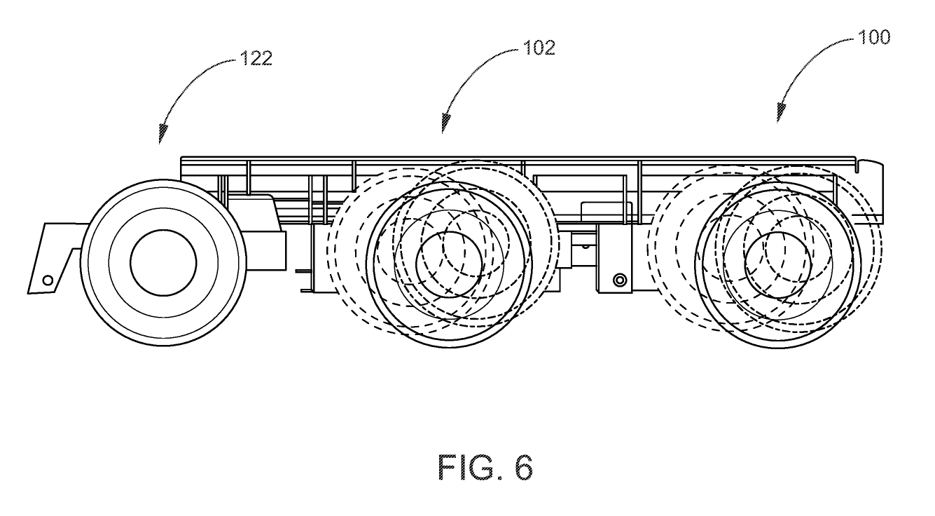

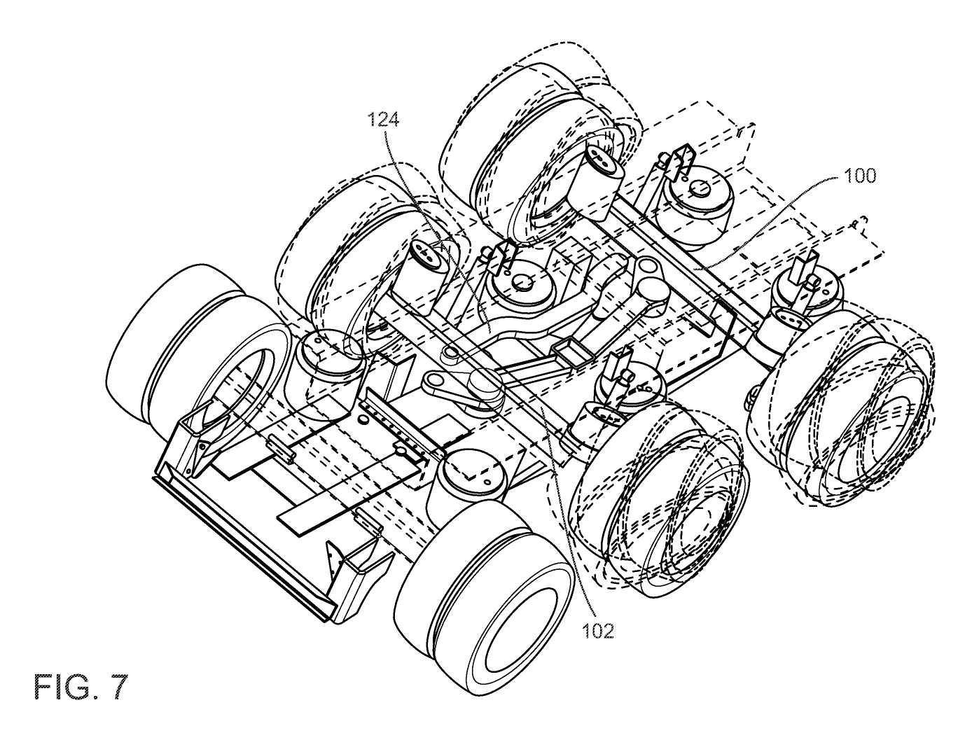

FIGS. 5-7 further illustrate the turning block and steering component arrangement of the first and second steering axles 100, 102. FIG. 7, in particular, shows the synchronizing member 124 associated with the first and second turning blocks 104, 116. Other components associated with the axles not related to steering may be conventional.

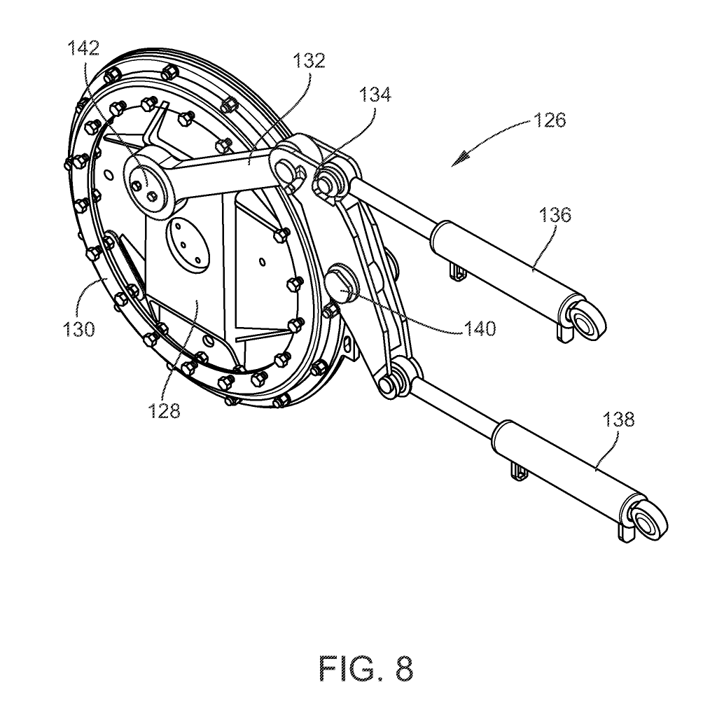

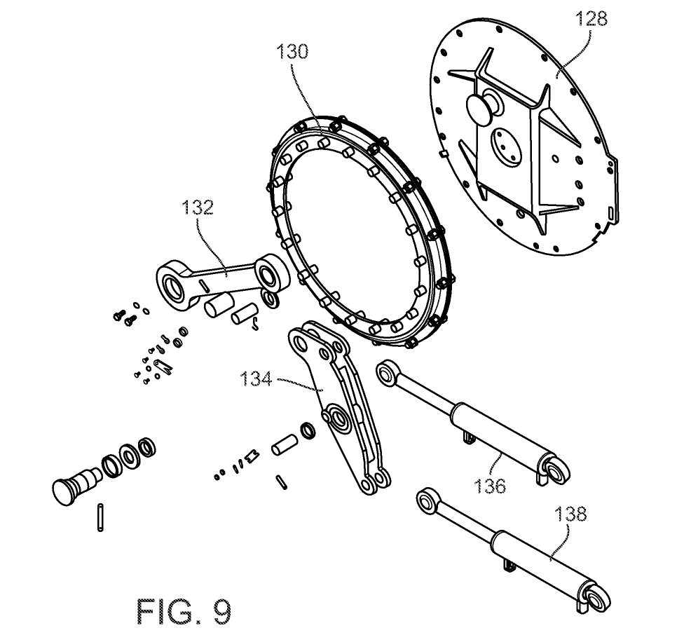

FIGS. 8 and 9 show a kingpin assembly according to the present invention. The kingpin assembly 126 generally includes a kingpin adapter 128, a turntable 130, a steering arm 132, a lever 134, and first and second command cylinders 136, 138. The lever 134 pivots about a vertical pivot axis 140. Piston ends of the first and second command cylinders 136, 138 pivotally attach proximate opposite ends of the lever 134, and on opposite sides of the pivot axis 140, such that rotation of the lever 134 in a first direction (e.g. clockwise) lengthens one command cylinder while shortening the other, and rotation of the lever in a second direction (e.g. counterclockwise) opposite the first direction has the opposite effect on the cylinder lengths. Actuation of the command cylinders causes actuation of the steering cylinders, for example through hydraulic conduits, thereby causing the wheels to steer in the commanded direction.

The steering arm 132 is pivotally attached at one end to a steering pivot 142 of the kingpin adapter 128, and pivotally attached at the opposing end thereof to one end of the lever 134. In this configuration, movement of the coupled kingpin adapter 128 causes movement of the steering arm 132, which causes pivoting movement of the lever 134 about the pivot axis 140 and consequential piston rod movement in the command cylinders 136, 138.

A desired steering ratio can be achieved by tuning one or more components of the system, for example, the length of the steering arm, lever or piston rods, etc.

The foregoing description provides embodiments of the invention by way of example only. It is envisioned that other embodiments may perform similar functions and/or achieve similar results. Any and all such equivalent embodiments and examples are within the scope of the present invention and are intended to be covered by the appended claims.

What is claimed is:

1. A steerable semi-trailer, comprising:
first and second steering axles arranged in a tandem configuration;
a first turning block coupled with the first steering axle and first and second steering cylinders;
a second turning block coupled with the second steering axle;
a synchronizing member coupling rotational movement of the first and second turning blocks; and
a kingpin assembly comprising a steering arm connected to a pivoting lever, and first and second command cylinders connected to opposing ends of the lever and hydraulically coupled to the first and second steering cylinders;
wherein movement of the steering arm causes pivoting movement of the lever, thereby actuating the first and second command cylinders thereby causing actuation of the first and second steering cylinders and consequential steering of the first and second steering axles.

2. The steerable semi-trailer of claim 1, further comprising a non-steering axle spaced apart from both the first and second steering axles.

3. The steerable semi-trailer of claim 2, wherein the first and second steering axles are proximate a back end of the semi-trailer and the non-steering axle is proximate a front end of the semi-trailer.

4. The steerable semi-trailer of claim 3, further comprising wheels arranged on each of the first and second steering axles and non-steering axle.

5. The steerable semi-trailer of claim 4, wherein the first turning block is rotatable and rotation of the first turning block steers wheels of the front axle.

6. The steerable semi-trailer of claim 5, wherein rotation of the first turning block is caused by actuation of the first and second steering cylinders, which are actuated by command cylinders associated with the kingpin assembly.

7. The steerable semi-trailer of claim 6, wherein the second turning block is associated with the rear axle and is interconnected with first and second steering arms associated with wheels of the rear axle.

8. The steerable semi-trailer of claim 7, wherein the first and second steering axles steer together in the same direction.

9. The steerable semi-trailer of claim 8, wherein the first and second steering axles steer together to the same degree.

10. The steerable semi-trailer of claim 7, wherein the first and second turning blocks are coupled together by the synchronizing member such that the first and second steering axles steer simultaneously in the same direction and degree.

11. The steerable semi-trailer of claim 10, wherein the lever of the kingpin assembly pivots about a vertical pivot axis and piston ends of the first and second command cylinders pivotally attach proximate opposite ends of the lever, and on opposite sides of the pivot axis, such that rotation of the lever in a first direction lengthens one command cylinder while shortening the other, and rotation of the lever in a second direction opposite the first direction has the opposite effect on the cylinder lengths with actuation of the command cylinders causing actuation of the steering cylinders thereby causing the wheels to steer in the commanded direction.

12. The steerable semi-trailer of claim 11, wherein the first direction of rotation of the lever is in a clockwise direction.

13. The steerable semi-trailer of claim 12, wherein the second direction of rotation of the lever is in a counterclockwise direction.
